(19) United States
(12) Patent Application Publication
(10) Pub. No.: US 2025/0290786 A1
(43) Pub. Date: Sep. 18, 2025

(54) FILL LEVEL METER

(71) Applicant: Endress+Hauser SE+Co. KG, Maulburg (DE)

(72) Inventors: Sylwester Szymanski, Schopfheim (DE); Philipp Hügler, Aalen (DE); Axel Schmidt, Kandern (DE)

(21) Appl. No.: 18/859,725

(22) PCT Filed: Mar. 28, 2023
(86) PCT No.: PCT/EP2023/057911

§ 371 Date: Oct. 24, 2024

(30) Foreign Application Priority Data
Apr. 27, 2022 (DE) 10 2022 110 191.6

(51) Int. Cl. G01F 23/284

(52) U.S. Cl. CPC G01F 23/284

(57) ABSTRACT

A radar based, fill level measuring device for fill level measurement in a container via a lateral opening of the container includes a tubular antenna arrangement having a linear tube axis, which is extendable through the container opening, a radar transparent cap, which media-tightly closes an end region of the antenna arrangement projecting into the container, and a beam direction changer arranged in the cap, whereby the radar signals are changed in direction off the tube axis and thence perpendicularly toward the fill substance. The fill level measuring device further includes a transmitting/receiving unit arranged at the opposite end region of the antenna arrangement. The cap may be a single piece to avoid possible joints, which increases pressure resistance, explosion protection, and the hygiene fitness of the fill level measuring device.

The invention relates to a fill level measuring device, which can be installed at small, lateral container openings.

In automation technology, especially for process automation, field devices are often applied, which serve for registering diverse measured variables. The measured variable to be determined can be, for example, a fill level, a flow, a pressure, the temperature, the pH value, the redox potential, a conductivity or the dielectric constant of a fill substance in a process plant. For registering the corresponding measured values, the field devices comprise suitable sensors based on suitable measuring principles. A large number of different field device types are manufactured and sold by the Endress+Hauser group of companies.

For fill level measurement of fill substances in containers, radar based measuring method have proven themselves. They are robust and low maintenance. A pivotal advantage of radar based measuring methods is their ability to measure fill level virtually continuously. In the context of the invention, the terminology, “radar”, means radar signals with frequencies between 0.03 GHz and 300 GHz. Usual frequency bands, at which fill level measurement is performed, are 2 GHZ, 26 GHZ, 79 GHZ, and 120 GHz. The two established measuring principles in such case are the pulse travel time principle (also known as “pulse radar”) and the FMCW principle (“Frequency Modulated Continuous Wave”). An example of a fill level measuring device working according to the pulse travel time method is described in Offenlegungsschrift DE 10 104 858 A1. A typical construction of an FMCW based fill level measuring device is described in Offenlegungsschrift DE 10 2013 108 490 A1. Further details concerning the FMCW and pulse radar measuring principles are described in “Radar Level Detection, Peter Devine, 2000”.

Since radar based, fill level measuring devices determine fill level indirectly, in that they measure distance from the surface of the fill substance from above, fill level measuring devices according to the state of the art are so designed that they are placed on top of the container. For this, the container is equipped on top with an appropriate connection, such as a flange connection. Often, such connections have to be separately retrofitted, while, in contrast, lateral connections on the container are often present per se, for example, as unused inlet, or outlets, or as connections for pressure or temperature measurement. A lateral installation on a container wall can, however, be burdened with the danger that the container wall receives at least part of the main radiation lobe of the transmitted radar signal, whereby disturbance reflections can occur, which lead to an incorrect fill level measurement.

DE 10 2020 106 020 A1 describes a radar based, fill level measuring device mounted laterally on a container, wherein the antenna arrangement there extends inwardly into the container in the form of a hollow tube. In such case, the antenna arrangement is designed to transmit the radar signal vertically downwards using an asymmetric bundling. In this way, reflection on the container wall is resisted. In the case of the fill level measuring device shown there, the asymmetric bundling is implemented via a corresponding aperture. In the case of DE 10 2020 106 020 A1, the antenna arrangement includes a corresponding radar optics. In such case, the radar optics is arranged in that end region antenna arrangement, which stands off, into the container interior, when the fill level measuring device is secured to the container. Above all concerning hygienic and explosion protection, this acts disadvantageously, since the corresponding joint between the radar optics and the antenna arrangement can be very susceptible to problems for these concerns.

An object of the invention, therefore, is to provide a lateral container opening mountable, fill level measuring device improved for such concerns.

The invention achieves the object by a radar based, fill level measuring device for measuring a fill level of a fill substance in a container, comprising:
a securement means, by means of which the fill level measuring device is securable at a lateral opening of the container,
a tubular antenna arrangement having
   a linear tube, or beam, axis, which is extendable through the container opening,
   a radar signal transparent cap, which media tightly closes a first end region of the antenna arrangement standing off into the container,
   a beam direction changer arranged in the cap in such a manner that the radar signals in the secured state of the antenna arrangement are changed in direction out of the beam axis and thence toward the fill substance, and vice versa, and
arranged in a second end region of the antenna arrangement, a transmitting/receiving unit, which is designed
   to transmit the radar signals along the tube, or beam, axis to the beam direction changer,
   after reflection of the radar signal on the surface of the fill substance, to receive via the beam direction changer corresponding received signals, and
   to ascertain the fill level based on the received radar signals.

Advantageous in the structure of the invention is that the radar transparent cap can, on the one hand, have a single piece construction, in order to avoid possible joints. This increases the pressure resistance and the hygiene fitness. Also, corresponding explosion protection specifications can be assured with corresponding dimensioning of the thickness of the cap. In order that the cap be transparent for radar signals, the cap can be made of PE, PFA, PEEK or PTFE material. The production method can be, for example, hot stamping or injection molding or a machining method. In order that the radar signal can be transmitted from the cap and, on return, enter into the cap as loss-free and reflection-free as possible, the cap advantageously has a thickness at least in the region of the leaving and entering radar signal equal to a whole numbered multiple of the half wavelength of the radar signal conveyed in the corresponding material.

An explosion protection conforming and pressure resistant connection between the tube of the antenna arrangement and the cap can be implemented, for example, by a snap connection, by means of which the cap is securable on the tube. In this connection, it is especially advantageous that the snap connection be designed in such a manner that it engages an outside of the tube.

The beam direction changer can be implemented, for example, as a metal coating on the appropriate area in the cap, for example, deposited by sputtering or PECVD 8 (“Plasma Enhanced Chemical Vapor Deposition”). Alternatively, the beam direction changer can also be implemented as a separate component within the cap, for example, adhered in the cap. Functioning as component, in such case, can be, for example, a corresponding metal substrate. Aluminum and stainless steel have in this regard correspondingly suitable reflective properties. Independently of whether the beam direction changer is implemented as a coating or as a separate component, the beam direction changer can be either planar or concavely curved. In the case of planar design, the radar signal is neither bundled nor scattered by the beam direction changer. When the beam direction changer is designed with a concave shape, such leads to an increased bundling of the radar signal to be transmitted into the container, and to an increased bundling of the received signal entering into the antenna arrangement. In this way, an increased sensitivity of the fill level measurement is obtained.

Alternatively or supplementally to a bundling beam direction changer, it is in the context of the invention, moreover, an option to arrange supplementally in the tube of the antenna arrangement, thus in the tube axis, a beam bundling means, which assumes the same function of a bundling beam direction changer. In order to affect radar signals virtually optically, the possible beam bundling means can, in turn, be made of correspondingly radar-refracting PE, PFA, PEEK or PTFE material. Especially advantageous in this connection is when the possible beam bundling means, or the beam direction changer, includes an aperture asymmetric in such a manner that the transmitted radar signal in the secured state of the antenna arrangement has an increased bundling relative to the container interior surface. In this way, an unintended reflection of the radar signal on the container wall is avoided. Moreover, it is advantageous in this connection that the beam direction changer, or the beam bundling means, be adapted for the transmitting/receiving unit, or its antenna, in a manner that the −10 dB aperture angle of the antenna coincides with the outer contour of the beam direction changer, or the outer contour of the beam bundling means, depending on whether the antenna arrangement includes a separate beam bundling means, or not.

From an explosion protection point of view, it is advantageous that the fill level measuring device, and the antenna arrangement, be constructed in such a manner that the transmitting/receiving unit in the secured state of the antenna arrangement be located outside of the container.

In connection with the transmitting/receiving unit, the terminology “unit” in the context of the invention means, in principle, any electronic circuit suitably designed for the contemplated application. It can be, thus, depending on requirements, an analog circuit for producing, and processing, corresponding analog signals. However, a digital circuit, such as an FPGA, or a storage means in cooperation with a program, can also be used. In such case, the program is designed to perform the corresponding method steps, or to apply the computer operations required for the unit. In this context, different electronic units of the dielectric constant measuring device can, within the scope of the invention, potentially also use a shared physical memory, or be operated by means of the same physical, digital circuit.

The invention will now be explained in greater detail based on the appended drawing, the figures of which show as follows:

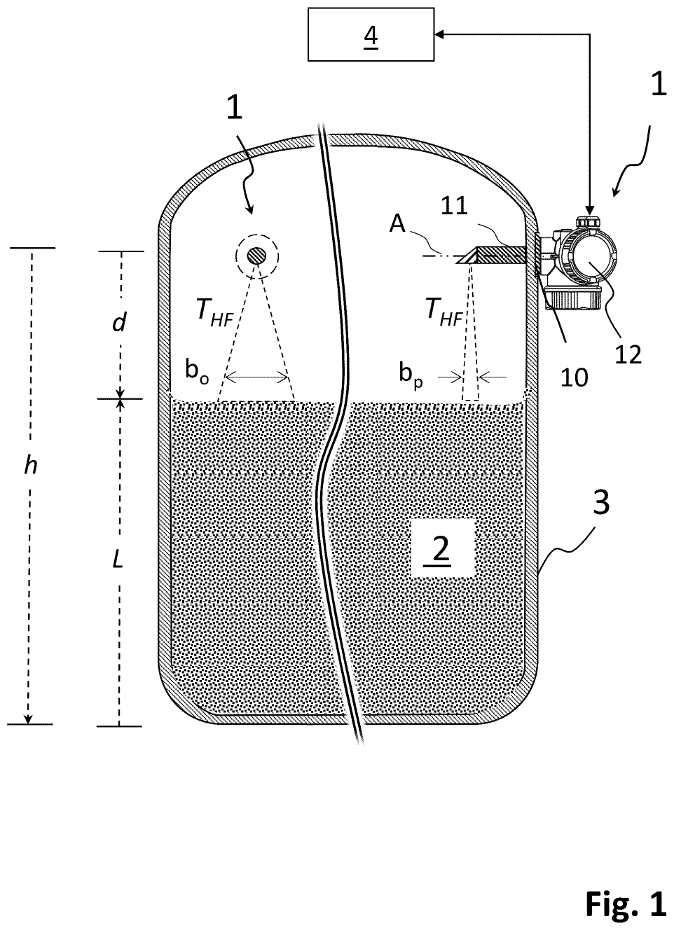

FIG. 1 a radar based, fill level measuring device of the invention at a lateral opening of a container, and

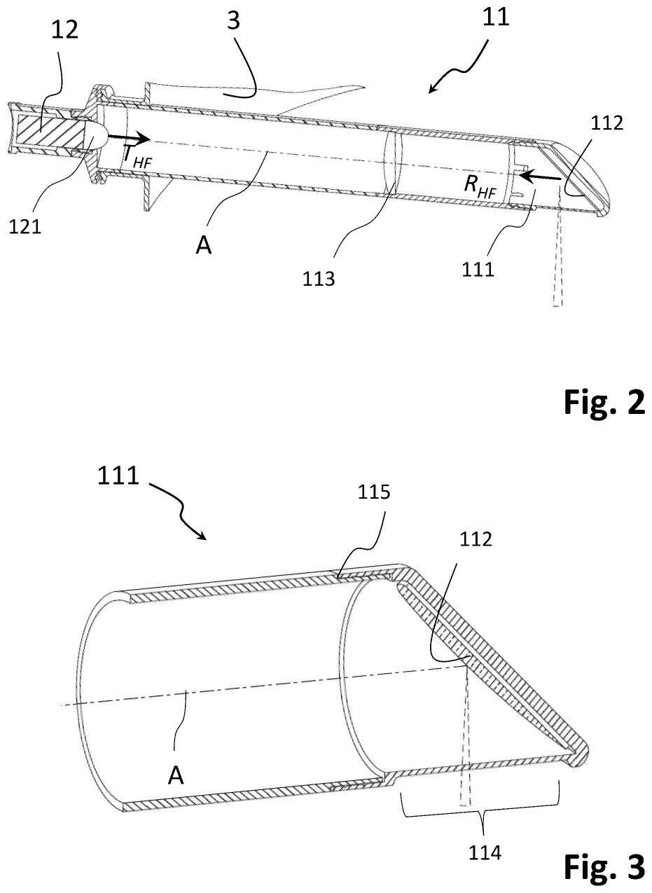

FIG. 2 a possible form of embodiment of the antenna arrangement of the fill level measuring device of the invention.

FIG. 3 a detail view of a first end region of the antenna arrangement standing off into the container.

For understanding the invention, FIG. 1 shows a freely radiating, radar based, fill level measuring device 1 arranged at a lateral container opening of a container 3. In such case, the lateral installation is necessary when mounting on the top is, in given cases, not adequately possible, for example, due to a curved top of the container 3. The container 3 can be, for example, part of a liquefied gas plant, wherein a corresponding fill substance 2 is located in the container 3. The determination of the fill level L of the fill substance 2 by the fill level measuring device 1 serves, for example, for control of possible inflows or outgoing flows of the container 3.

For this, the fill level measuring device 1 can be connected via a bus system, such as, for instance, “Ethernet”, “PROFIBUS”, “HART” or “wireless HART”, to a superordinated unit 4, for example, a process control system or a decentral database. In this way, the current fill level L can be transmitted, in order that the process control system can, in given cases, control inflows or outgoing flows of the container 3. Also information concerning the operating state of the fill level measuring device 1 can be communicated via the bus system.

In order to be able reliably to ascertain the fill level L, the fill level measuring device 1 in the case of a lateral arrangement needs to be arranged at a container opening located above the maximum fill level L of the fill substance 2. In such case, the installed height h above the floor of the container 3 is known, and, for instance, stored in the fill level measuring device 1. Additionally, the fill level measuring device 1 is secured pressure-tightly and media-tightly at the container opening in such a manner that only the tubular antenna arrangement 11 of the fill level measuring device 1 stands off, for instance, horizontally, into the container 3, while the other components of the fill level measuring device 1 are arranged outside of the container 3. For installation of the fill level measuring device 1, the tubular shape of the antenna arrangement 11 needs, moreover, to be sufficiently compactly designed, such that it can be led through the container opening for the mounting of the fill level measuring device 1. In such case, depending on process, only a very small lateral container opening can be available, for example, one having a DN20 diameter. After passage of the antenna arrangement 11 through the lateral container opening and into the container, the fill level measuring device 1 can be secured at the lateral opening of the container by means of a suitable securement means 10, such as a flange connection.

The antenna arrangement 11 is so designed that via its first end region 12, which stands off into the container interior, transmitted radar signals T_{HF} are transmitted within a predefined frequency band in the direction of the surface of the fill substance 2. After reflection on the surface of the fill substance 2, the fill level measuring device 1, in turn, receives the reflected received signals R_{HF} via such end region. In such case, the signal travel time t between transmitting and receiving a radar signal T_{HF} is

$$t = \frac{2 * d}{c}$$

and is, thus, proportional to the distance d between the fill level measuring device 1 and the fill substance 2, wherein c stands for the radar propagation velocity of the 19 appropriate speed of light. The signal travel time t can be determined by the fill level measuring device 1, for example, by means of the FMCW method or by means of the pulse travel time method. In this way, the fill level measuring device 1 can, for example, based on a corresponding calibration, associate the measured travel time t with a distance d. Then the fill level measuring device 1 can determine the fill level L using

$$d = h - L$$

when the installed height h is stored in the fill level measuring device 1, or, when before start-up, a corresponding zero point reconciliation is performed. For producing the transmitted radar signal T_{HF} and for determining the signal travel time t, and the corresponding fill level value L, based on the received signal R_{HF}, the fill level measuring device 1 includes a correspondingly designed transmitting/receiving unit 12, in which, for example, the FMCW or the pulse travel time, measuring principle is implemented.

As can be seen from FIGS. 1 and 2, the transmitting/receiving unit 12 of the fill level measuring device 1 of the invention is arranged at the second end region of the tube 11 lying opposite the first end region standing off in the container 3. In this way, the transmitting/receiving unit 12 is located in the mounted state of the fill level measuring device 1 outside of the container 3. This facilitates the meeting of explosion protection specifications, since then no active, i.e., electrical current carrying, component is located in the antenna arrangement 12, thus, within the container 3.

FIG. 2 shows that the transmitting/receiving unit 12 transmits the transmitted radar signal T_{HF} within the antenna arrangement 11 along the linear tube axis A. For this, the transmitting/receiving unit 12 includes a corresponding antenna 121, which is oriented toward the first end region. In such case, the antenna 121 can be designed, for example, as a patch antenna with connected upstream lens.

According to the invention, arranged in the first end region, thus, the end region standing off in the container 3, in the beam axis A of the antenna 121, is a beam direction changer in the form of a beam turning mirror 112. Such is so designed and arranged that the transmitted radar signal T_{HF} is turned there by 90° downwards, perpendicularly to fill substance 2. By reciprocal reflection properties of the beam turning mirror 112, also the received signal R_{HF} incoming from the surface of the fill substance 2 is deflected by the beam turning mirror 112 by 90° into the beam axis A of the transmitting/receiving unit 12. In this way, the received signal R_{HF} can then be received by the antenna 121 and appropriately evaluated by the transmitting/receiving unit 12. In such case, the beam turning mirror 112 can preferably be implemented based on a metal substrate or a metal coating.

Beam turning mirror 112 is surrounded by a cap 111, which is virtually transparent for the radar signals T_{HF}, R_{HF}. For this, the cap 111 is produced as a single piece of correspondingly transparent material, such as PE, PEEK or PTFE material. In such case, the region 114 of the cap 111, through which the radar signal S_{HF}, R_{HF} leaves and enters, can have a thickness equaling a whole numbered multiple of the half wavelength, with which the radar signal propagates in the material of the cap. This hinders reflections and disturbance echoes of the radar signal in region 114. Advantageous in the one piece design of the cap 111 is that a certain overpressure resistance and explosion protection can be achieved thereby.

The media-tight and overpressure resistant securing of the cap 111 on the antenna arrangement 11 is achieved in the embodiment shown in FIG. 2 and FIG. 3 by a snap connection 115. For this, the snap connection 115 comprises tube axis surrounding, snap hooks, which in the illustrated embodiment are arranged on the cap 111. It is advantageous in this connection, when the snap connection 115 is so designed that it engages the outside of the tube 11. In this way, possible gaps between the cap 111 and the tube of the antenna arrangement are reduced, whereby the fill level measuring device 1 of the invention can be better used for hygienically sensitive applications.

In order that the transmitted radar signal T_{HF} has no reflections on the inner surface of the antenna arrangement 11, the transmitting/receiving unit must transmit the radar signal S_{HF} with an effective bundling relative to the tube diameter. In this connection, it is advantageous to produce, and after receipt to process, the radar signal S_{HF}, R_{HF} with an as high as possible frequency of preferably 120 GHZ, since the bundling at constant dimensions of the antenna 121 increases with increasing frequency. In this way, it is possible to dimension the tube outer diameter of the antenna arrangement 11 at DN100 or less.

As can be seen from comparison of the front and side views of fill level measuring device 1 in FIG. 1, the bundling bₚ, bₒ of the antenna arrangement 12 is asymmetric: In parallel with axis A of the antenna arrangement, the bundling bₚ is about three times as much as the bundling bₒ parallel to the container wall. In this way, the main radiation lobe of the radar signal T_{HF} is correspondingly more bundled relative to the container wall, whereby the container interior surface does not disturbingly reflect the radar signal T_{HF}.

The corresponding, asymmetric aperture is implemented by a radar bundling optics 113, which is arranged in the tube of the antenna arrangement 11 on the beam axis A. In such case, the radar bundling optics 113 is optimally arranged in the tube and adapted to the antenna 121 of the transmitting/receiving unit 12 in such a manner that the antenna 121 completely illuminates the radar bundling optics 113 with the transmitted radar signal T_{HF}. i.e., the outer contour of the lens shaped radar bundling optics 113 is illuminated by the radar signal T_{HF}, and by the antenna 121, with the −10 dB lobe width relative to the main beam axis A. The bundling maximizes the intensity of the transmitted radar signal T_{HF}. It is, depending on the length of the antenna arrangement 11, also an option not to construct the radar bundling optics 113 asymmetrically.

The variant of the antenna arrangement 11 shown in FIGS. 2 and 3 has a round tubular cross-sectional shape corresponding to that of the container opening. Of course, the tube of the antenna arrangement 11 can corresponding to the container opening also be designed with any other cross-section, such as, for example, a rectangular cross-section. Moreover, optionally, the fill level measuring device 1 can, counter to the embodiment shown in FIG. 1, also be constructed other than that the antenna arrangement stands off inwardly at 90° relative to the container interior surface. Instead, it is also an option that the fill level measuring device 1 be so constructed that the antenna arrangement 11 especially stands off at an angle between 45° and 135° in the container 3. In such case, the beam direction changer 112 is to be constructed corresponding to such angle.

### LIST OF REFERENCE CHARACTERS

1 fill level measuring device
2 fill substance
3 container
4 superordinated unit
10 securement means
11 antenna arrangement
12 transmitting/receiving unit
31 container opening
111 cap
112 beam direction changer
113 beam bundling means
114 region of the cap
115 snap connection
121 antenna
A tube, and beam, axis
bₒ bundling orthogonal to the tube axis
bₚ bundling parallel to the tube axis
d distance
h installed height of the fill level measuring device
L fill level
R_{HF} received radar signal
T_{HF} transmitted radar signal

1-10. (canceled)

11. A radar based, fill level measuring device for measuring a fill level of a fill substance in a container, the measuring device comprising:
a connection by which the fill level measuring device is securable at a lateral opening of the container;
a tubular antenna arrangement, including:
a linear tube, having a tube axis, which is extendable through the container opening;
a transparent cap, which is transparent to radar signals and is configured to media-tightly close a first end region of the antenna arrangement, which projects into the container in a secured state of the antenna arrangement; and
a beam direction changer arranged in the cap such that, in the secured state, the radar signals are changed in direction off the tube axis and hence toward the fill substance, and vice versa; and
a transmitting/receiving unit arranged at an opposite second end region of the antenna arrangement and configured to:
transmit the radar signals along the tube axis to the beam direction changer;
after reflection of the radar signal from the surface of the fill substance, receive corresponding received signals via the beam direction changer; and
determine the fill level based on the received radar signals.

12. The measuring device according to claim 11, wherein the cap is made as a single piece of PE, PFA, PEEK, or PTFE material.

13. The measuring device according to claim 12, wherein the cap has a thickness in a region of exiting and entering radar signals equal to a whole numbered multiple of a half-wavelength of the radar signal conveyed through the material.

14. The measuring device according to claim 11, wherein the beam direction changer is a metal coating, or
wherein the beam direction changer is adhered as a metal substrate.

15. The measuring device according to claim 14, wherein the metal coating is deposited by sputtering or plasma enhanced chemical vapor deposition (PECVD).

16. The measuring device according to claim 14, wherein the metal substrate is planar.

17. The measuring device according to claim 11, further comprising a beam bundling means arranged within the tube on the tube axis.

18. The measuring device according to claim 17, wherein the beam bundling means is made of PE, PFA, PEEK, or PTFE material.

19. The measuring device according to claim 17, wherein the beam bundling means has an asymmetric aperture such that the transmitted radar signal has an increased bundling toward the container interior surface in the secured state of the antenna arrangement.

20. The measuring device according to claim 11, wherein the cap is configured to be secured on the tube with a snap connection.

21. The measuring device according to claim 20, wherein the snap connection is configured so as to engage an outside of the tube.

22. The measuring device according to claim 11, wherein the beam direction changer, or the beam bundling means, is adapted for the transmitting/receiving unit such that a −10 dB lobe width of the transmitted radar signal coincides with an outer contour of the beam direction changer, or the beam bundling means.

23. The measuring device according to claim 11, wherein the transmitting/receiving unit is arranged outside of the container in the secured state of the antenna arrangement.
